(19) United States
(12) Patent Application Publication
(10) Pub. No.: US 2022/0147547 A1
(43) Pub. Date: May 12, 2022

(54) ANALOGY BASED RECOGNITION

(71) Applicant: International Business Machines Corporation, Armonk, NY (US)

(72) Inventors: Shikhar Kwatra, San Jose, CA (US); Sushain Pandit, Austin, TX (US); Paul N. Krystek, Highland, NY (US); Sarbajit K. Rakshit, Kolkata (IN)

(21) Appl. No.: 17/095,879

(22) Filed: Nov. 12, 2020

(51) Int. Cl. G06F 16/335; G06F 16/36; G06N 5/02; G06F 16/338

(52) U.S. Cl. CPC G06F 16/337; G06F 16/338; G06N 5/025; G06F 16/367

(57) ABSTRACT

Aspects of the present disclosure include determining an ontology for a user, determining a concept for the user, analyzing the concept and the ontology for the user to determine a familiarity score for the concept, and determining an analogous concept for the concept responsive to determining that the familiarity score is below a threshold familiarity score.

### BACKGROUND

The present invention generally relates to natural language processing (NLP) and recognition, and more specifically, to analogy based recognition.

Natural language processing (NLP) is a field of computer science, artificial intelligence, and linguistics concerned with the interactions between computers and human (natural) languages. Many NLP systems make use of ontologies to assist in performing NLP tasks. An ontology is a representation of knowledge that is typically represented via a knowledge graph having nodes and edges. NLP can be utilized to search knowledge graphs and provide recognition of objects, items, relationships, concepts, and the like. However, for understanding unfamiliar objects, items, relationships, or concepts, it is often more helpful to an individual to draw upon their own understanding of certain topics to provide an analogy that explains the unfamiliar object, concept, or topic. There exists a need for personalized analogy comparisons to assist an individual with identifying, understanding, and/or recognizing objects, items, relationships, concepts, and the like.

### SUMMARY

Embodiments of the present invention are directed to a computer-implemented method for analogy based recognition. A non-limiting example of the computer-implemented method includes determining an ontology for a user, determining a concept for the user, analyzing the concept and the ontology for the user to determine a familiarity score for the concept, and determining an analogous concept for the concept responsive to determining that the familiarity score is below a threshold familiarity score.

Embodiments of the present invention are directed to a system for analogy based recognition. A non-limiting example of the system includes a processor communicatively coupled to memory, the processor configured to perform determining an ontology for a user, determining a concept for the user, analyzing the concept and the ontology for the user to determine a familiarity score for the concept, and determining an analogous concept for the concept responsive to determining that the familiarity score is below a threshold familiarity score.

Embodiments of the invention are directed to a computer program product for analogy based recognition, the computer program product comprising a computer readable storage medium having program instructions embodied therewith. The program instructions are executable by a processor to cause the processor to perform a method. A non-limiting example of the method includes determining an ontology for a user, determining a concept for the user, analyzing the concept and the ontology for the user to determine a familiarity score for the concept, and determining an analogous concept for the concept responsive to determining that the familiarity score is below a threshold familiarity score.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for analogy based recognition according to embodiments of the invention;

FIG. 5 depicts a diagram of knowledge graphs and drawing an analogy according to one or more embodiments of the invention; and

FIG. 6 depicts a flow diagram of a method for analogy based recognition according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

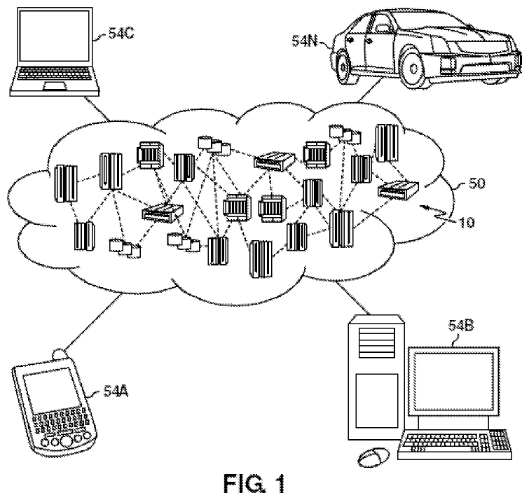

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

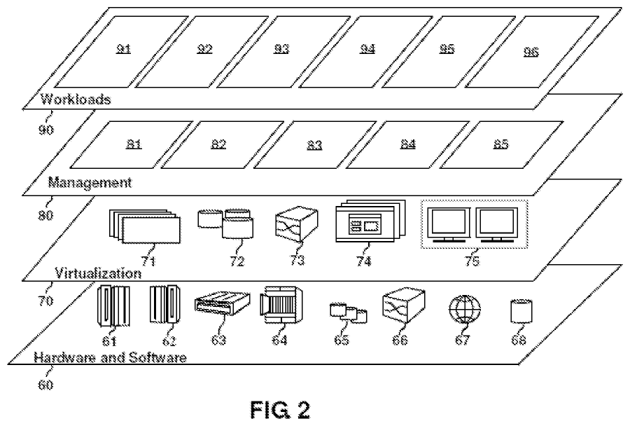

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and analogy based recognition 96.

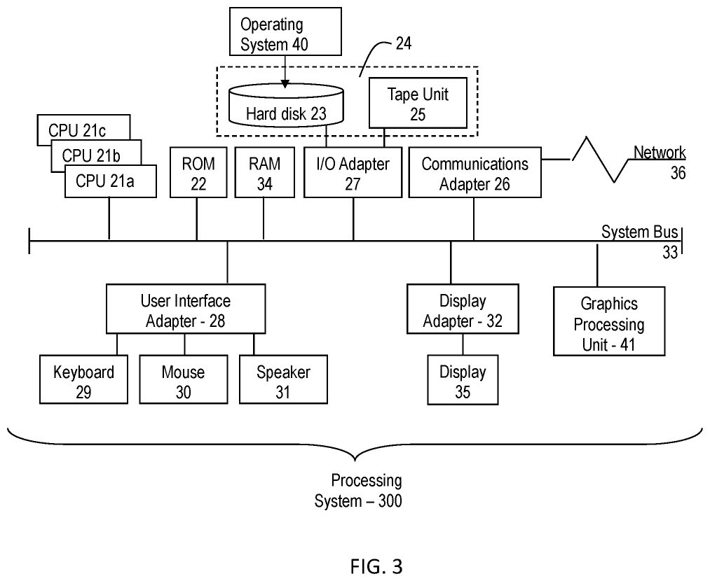

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

It is to be understood that the block diagram of FIG. 3 is not intended to indicate that the computer system 300 is to include all of the components shown in FIG. 3. Rather, the computer system 300 can include any appropriate fewer or additional components not illustrated in FIG. 3 (e.g., additional memory components, embedded controllers, modules, additional network interfaces, etc.). Further, the embodiments described herein with respect to computer system 300 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Turning now to an overview of technologies that are more specifically relevant to aspects of the invention, identifying and exploring new or unknown concepts can be a challenge for individuals especially when the new or unknown concept is in a difficult field for an individual. Typically, when attempting to describe or teach a new concept, an individual will look to analogize the concept with a known concept to facilitate a faster understanding. However, identifying and presenting an analogous concept can be difficult because one must first understand an individual's base knowledge to formulate an analogy for the individual. For example, when attempting to describe or teach the concept of voltage in an electrical circuit to an individual, it would be helpful to understand the individual's background knowledge to first have a starting point to describe the concept and to also come up with a good analogy for the concept to help the individual understand. If the individual has a background in plumbing or has significant experience with plumbing, describing the concept of voltage could be analogized with the familiar concept of water pressure through a pipe where the pressure is affected by the pipe's sizing similar to how voltage and resistance work in an electrical circuit.

Turning now to an overview of the aspects of the invention, one or more embodiments of the invention address the above-described problem by providing an intelligent system that can predict a difficulty for a user in understanding a concept and then present an analogous concept based on the user's base knowledge. Herein, broadly speaking, concept can include its plain meaning and include any type of object, item, relationship, physical property, topic, and the like. For example, a concept can be like the concept of voltage or it could be an item such as a resistor or a topic like cryptocurrency. The intelligent system can draw upon one or more analogies based on a user's historical knowledge to assist the user with recognizing a concept. The intelligent system can present the analogy to the user for further understanding through one or more of text, graphics, animations, video, audio, and the like.

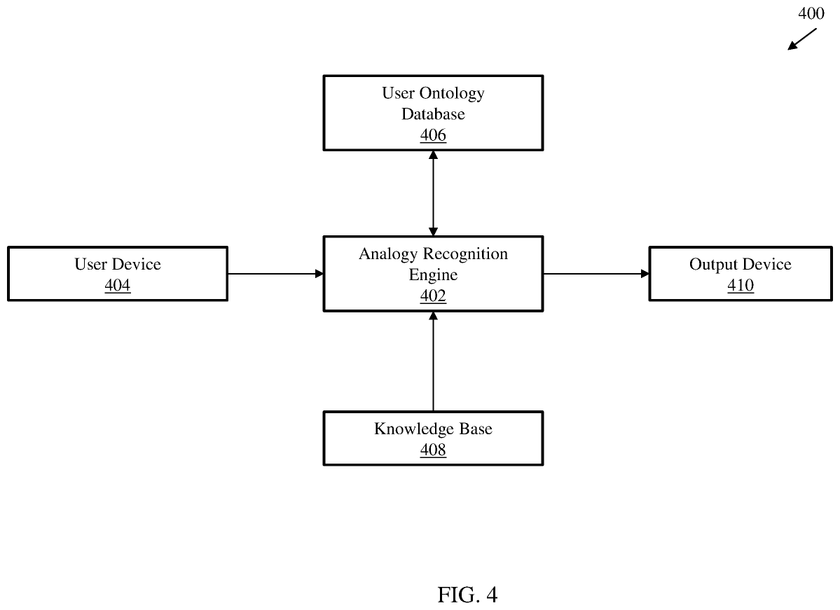

Turning now to a more detailed description of aspects of the present invention, FIG. 4 depicts a block diagram of a system for analogy based recognition according to embodiments of the invention. The system 400 includes an analogy recognition engine 402. The system 400 also includes a user device 404, user ontology database 406, a knowledge base 408, and an output device 410. In one or more embodiments of the invention, the analogy recognition engine 402 is operable to receive data from the user device 404 to determine the presence of a concept that a user of the user device 404 may or may not be familiar with. The user device 404 can include sensors such as a camera that can implement image recognition to identify concepts that a user interacts with. In one or more embodiments of the invention, the user device 404 can include, but is not limited to, a smart phone, a smart watch, a laptop, desktop, a wearable sensor and/or computing device, and the like. Also, the user device 404 can include inputs for identifying concepts where a user can input a concept that the user may be unfamiliar with or the input can be a web browser application, any social media application, or the like that the user operates on the user device 404. These concepts, once identified, can be analyzed by the analogy recognition engine 402 along with the user ontology stored in the user ontology database 406

An ontology is a representation of knowledge. In this case, the user ontology is a representation of the user's knowledge. Ontologies are often represented or modeled in hierarchical structures in which portions of knowledge may also be represented as nodes in a graph and relationships between these portions of knowledge can be represented as edges between the nodes. Examples of structures such as taxonomies and trees are limited variations, but generally speaking, ontology structures are highly conducive to being represented as a graph. The analogy recognition engine 402 can build this user ontology and store it in the user ontology database 406 for later analysis. The user ontology can be created based on a user's background that includes their education level, field of study, employment data, and any other historical data for the user. The user ontology can further be built based on past interactions a user has had with certain concepts. For example, a user may be an avid soccer player, and this could indicate a familiarity with how the rules, such as offsides, works. This interaction with the concepts learned while playing the game of soccer could be later used to explain similar or analogous rules for sports that the user may not be familiar with such as hockey which includes a similar rule as offsides.

In one or more embodiments of the invention, the analogy recognition engine 402 can utilize a variety of techniques for building the user ontology based on the available data for the user. These techniques include, but are not limited to, natural language processing (NLP), machine learning (ML), semantic analysis, relation extraction and annotation analysis, entity detection, and the like. These techniques can analyze the data associated with the user (e.g., historical data, interaction data, internet data, social media data, and the like) and build the user ontology in the form of, for example, a knowledge graph with nodes and edges that represent concepts and relationships that the user is familiar with. The collection of the data associated with the user can be performed by the user device 404 obtaining inputs through sensors that tracks a user's activity performed at different time frames, locations, and the like. In addition, the user device 404 can collect user mobility patterns, gestures, speech and vocabulary to build upon the user ontology and to identify concepts that the user may not be familiar with. This can include historical webpage and browsing content and social media data logged by the user device 404 to identify gathered knowledge over a period of time. The analogy recognition engine 402 can continuously update the user ontology as data is being gathered on the user by the user device 404.

In one or more embodiments of the invention, the characteristics of the nodes and the edges in a knowledge graph in the user ontology can indicate the user's familiarity with certain concepts. For example, edge line lengths or nodes sizes can indicate familiarity with the concepts and their relationships with other concepts in the knowledge graph representation of the user ontology.

In one or more embodiments of the invention, the analogy recognition engine 402 builds upon the user ontology knowledge graph structure by accessing data from the knowledge base 408 and creating metadata for concepts and relationships among the concepts in the user ontology. While creating this metadata, the analogy recognition engine 402 searches the knowledge base 408 which includes internet searches and other databases and existing ontologies. The metadata for the user ontology can include, for example, appropriate classes for certain concepts such as, for example, technology classes, financial classes, etc.

In one or more embodiments of the invention, the analogy recognition engine 402 can build knowledge graphs or other similar structures for a concept that a user is unfamiliar. This can occur when the user device 404 identifies a concept that the user is having an interaction with. The concept can include a variety of things such as, for example, web page content, physical object, topics of discussion, and the like. The analogy recognition engine 402 can look to the user ontology and determine that a user is unfamiliar with a concept based on a determined familiarity score as compared to a threshold familiarity score.

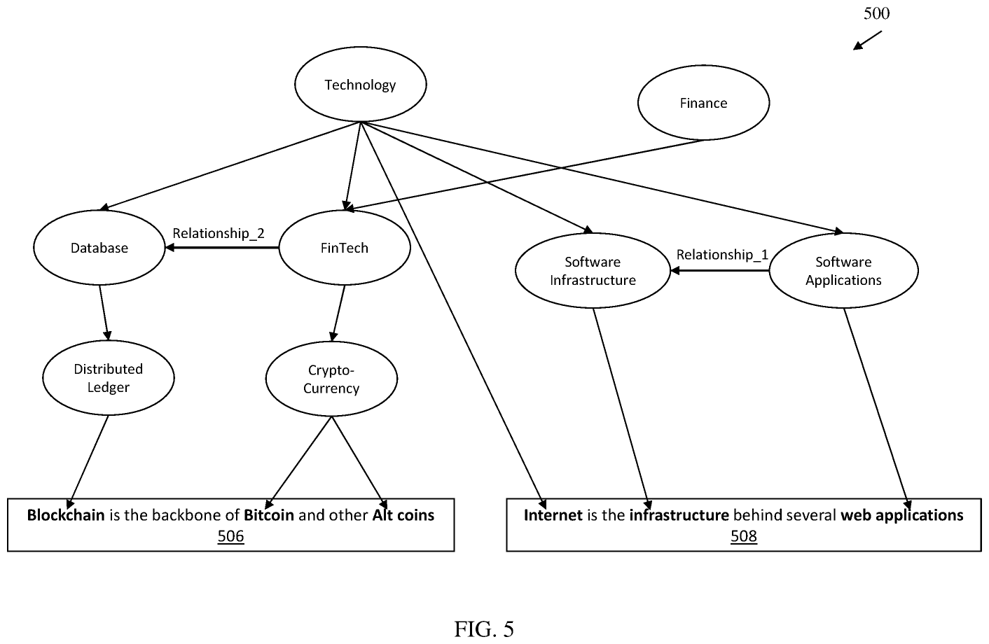

FIG. 5 depicts a diagram of knowledge graphs and drawing an analogy according to one or more embodiments of the invention. The diagram 500 illustrates the analogy recognition engine 402 drawing an analogy to assist a user with understanding how a “blockchain” is related to “bitcoin.” The analogy recognition engine 402 can determine that a user is unfamiliar with how a blockchain is related to bitcoin by analyzing the user ontology and determining a familiarity score between this concept and the user's knowledge. If the familiarity score is below a certain threshold, the analogy recognition engine 402 then analyzes the user ontology and accesses additional data from the knowledge base 408 to determine an appropriate analogy to present for the user. The knowledge graphs depicted in FIG. 5 include data taken from the user ontology which identifies that the user, in this example, is familiar with software infrastructure and software applications and the relationship between software infrastructure and software applications. The analogy recognition engine 402 looks to map two distinct analogies (506, 508) into a common model utilizing, among other techniques, relationship extraction. When determining an appropriate analogy, the analogy recognition engine 402 can search the user ontology database 406 to identify if any analogy if found based on the user's ontology. In one or more embodiments of the invention, the analogy recognition engine 402 can build a knowledge graph for the unknown or unfamiliar concept for the blockchain and bitcoin based on data obtained from the knowledge base 408. The analogy recognition engine 402 can perform a semantic search on the graphs that have been constructed stating from concepts in the first analogy 506 for blockchains and bitcoin and stop the algorithm when finding concepts for the second analogy 508 (internet, etc.). The analogy recognition engine 402 can score this indirect relationship between the two analogies (506, 508) based on the number of connected paths. In the illustrated example, the analogies (506, 508) have two connected paths through Technology. Based on this scoring of the analogies, the analogy recognition engine 402 can then present the analogies to the user through the output device 410. In one or more embodiments of the invention, the output device 410 can be separate from the user device 404 or can be part of the user device 404 such as a display screen or audio output. The analogies 506, 508 can be presented to the user through one or more of text, audio, video, and the like.

In one or more embodiments of the invention, the analogy recognition engine 402 can determine that a set of analogies do not have a high enough score as compared to a threshold score and can look to other ontologies of similarly situated users taken from, for example, population data. The other ontologies can be searched using similar techniques to identify analogies for presentation to the user based on characteristics of the user as compared to other users' characteristics. For example, for a user in a certain region of the world, the analogy recognition engine 402 can search users in the same or similar region to assist with presenting a high scoring analogy. Further, in some embodiments, the analogy recognition engine 402 can receive feedback from the user and the other users related to the quality of the analogy in teaching the concept. This feedback can be utilized to update the user's ontology as well as assist when searching other users' ontologies. The scoring between analogies can be based on the user feedback across multiple users having similar characteristics.

In one or more embodiments, the analogy recognition engine 402 can utilize one or more sensors and/or components of the user device 404 to automatically identify an unknown concept for the user by first identifying the concept and comparing the concept to the user's ontology. The analogy recognition engine 402 can then highlight the unknown concept on the output device 410. For example, if a user is reading a website and a concept is identified as unknown to the user by the analogy recognition engine 402, the concept can be highlighted and/or augmented to draw the user's attention to the unknown concept. The user can select the concept using a mouse pointer, a stylus, or finger. Once selected, the analogy recognition engine 402 can generate a pop-up window with a determined analogy for the user. The pop-up window can display text, a URL, audio, video, and/or animation to present the analogy for the user. In one or more embodiments of the invention, the user can utilize the user device 404 to capture image or video data of an unknown concept and display this image and video data at the output device 410 which can be a screen for the user device 404. The concept can be determined using image recognition and then an analogy can be determined by the analogy recognition engine 402. Once an analogy is determined, the analogy can be presented to the user via the output device in the form of a text, video, or animation which can be overlaid over the image and/or video data taken by the user device 404. This overlay of the analogy can be done in real-time as the user is recording the concept with the user device 404.

In one or more embodiments of the invention, the analogy recognition engine 402 can be implemented on the processing system 300 found in FIG. 3. The processing steps described with reference to the elements of FIG. 4 can be performed utilizing the processing system 300 in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In embodiments of the invention, the analogy recognition engine 402 can also be implemented as so-called classifiers (described in more detail below). In one or more embodiments of the invention, the features of the various engines/classifiers (402) described herein can be implemented on the processing system 300 shown in FIG. 3 or can be implemented on a neural network (not shown). In embodiments of the invention, the features of the engines/classifiers 402 can be implemented by configuring and arranging the processing system 300 to execute machine learning (ML) algorithms. In general, ML algorithms, in effect, extract features from received data (e.g., inputs to the engines 402) in order to “classify” the received data. Examples of suitable classifiers include but are not limited to neural networks (described in greater detail below), support vector machines (SVMs), logistic regression, decision trees, hidden Markov Models (HMMs), etc. The end result of the classifier's operations, i.e., the “classification,” is to predict a class for the data. The ML algorithms apply machine learning techniques to the received data in order to, over time, create/train/update a unique “model.” The learning or training performed by the engines/classifiers 402 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In embodiments of the invention where the engines/classifiers 402 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 400 can be implemented using the processing system 300 applies.

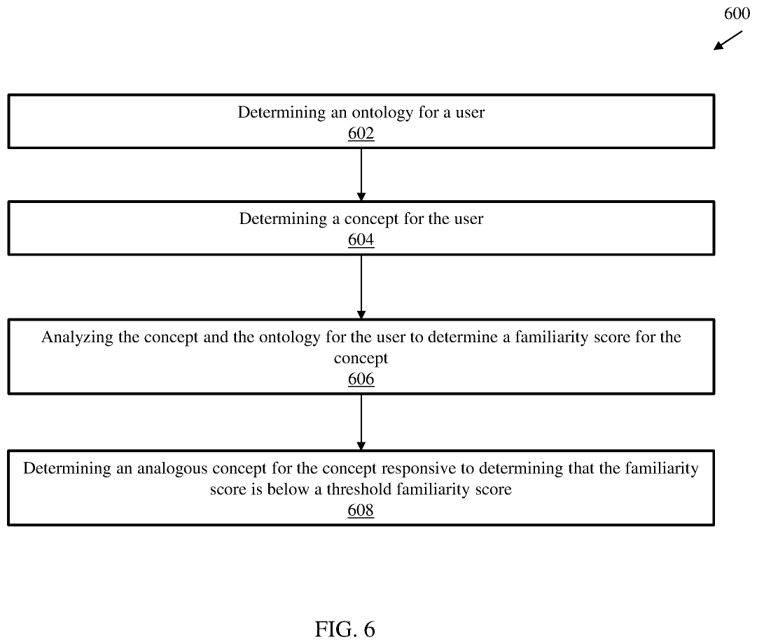

FIG. 6 depicts a flow diagram of a method for analogy based recognition according to one or more embodiments of the invention. The method 600 includes determining an ontology for a user, as shown block 602. Determining the ontology can be taken from data associated with the user. Next, at block 604, the method 600 includes determining a concept for the user. This concept can be determined based on an interaction of the user with the concept such as coming across the concept while performing an interne search, for example. The method 600 continues, at block 606, by analyzing the concept and the ontology for the user to determine a familiarity score for the concept. And at block 608, the method 600 includes determining an analogous concept for the concept responsive to determining that the familiarity score is below a threshold familiarity score.

Additional processes may also be included. It should be understood that the processes depicted in FIG. 6 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or obj ect code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
determining an ontology for a user;
determining a concept for the user;
analyzing the concept and the ontology for the user to determine a familiarity score for the concept; and
determining an analogous concept for the concept responsive to determining that the familiarity score is below a threshold familiarity score, wherein determining the analogous concept comprises:
constructing a first knowledge graph for the concept based on knowledge base data:
performing a semantic analysis on the ontology of the user, wherein the ontology of the user comprises at least one knowledge graph;
identifying a candidate analogous concept in the ontology of the user based on the semantic analysis;
determining a score for the candidate analogous concept based on a number of connected relationship paths between the concept in the first knowledge graph and the candidate analogous concept in the at least one knowledge graph; and
returning the candidate analogous concept as the analogous concept based on a determination that the score for the candidate analogous concept exceeds a threshold score.

2. The computer-implemented method of claim 1, further comprising presenting the analogous concept to the user.

3. The computer-implemented method of claim 1, wherein determining the concept for the user comprises:
obtaining, by a sensor associated with a user device, sensor data taken from an interaction of the user with the concept; and
accessing the ontology for the user and a knowledge base to identify the concept using the sensor data.

4. (canceled)

5. The computer-implemented method of claim 1, wherein determining the analogous concept further comprises:
determining that the score for the candidate analogous concept does not exceed the threshold score;
accessing a second knowledge graph and performing a second semantic analysis on the second knowledge graph;
identifying a second candidate analogous concept in the second knowledge graph based on the second semantic analysis;
determining a second score for the second candidate analogous concept based on a second number of connected relationship paths between the concept in the first knowledge graph and the second candidate analogous concept in the second knowledge graph; and
returning the second candidate analogous concept as the analogous concept based on a determination that the second score for the second candidate analogous concept exceeds the threshold score.

6. The computer-implemented method of claim 5, wherein the second knowledge graph is accessed from a second user ontology associated with a second user.

7. The computer-implemented method of claim 2, further comprising:
receiving feedback from the user based on the presenting the analogous concept to the user; and
updating the ontology of the user based on the feedback.

8. The computer-implemented method of claim 1, wherein determining the ontology for the user comprises constructing at least one knowledge graph based on historical data associated with the user.

9. The computer-implemented method of claim 8, wherein the historical data comprises at least one of social media data, internet browsing data, demographic data, and historical interactions of the user.

10. A system comprising:
a processor communicatively coupled to a memory, the processor configured to:
determine an ontology for a user;
determine a concept for the user;
analyze the concept and the ontology for the user to determine a familiarity score for the concept; and
determine an analogous concept for the concept responsive to determining that the familiarity score is below a threshold familiarity score, wherein determining the analogous concept comprises:
constructing a first knowledge graph for the concept based on knowledge base data;
performing a semantic analysis on the ontology of the user, wherein the ontology of the user comprises at least one knowledge graph;
identifying a candidate analogous concept in the ontology of the user based on the semantic analysis;
determining a score for the candidate analogous concept based on a number of connected relationship paths between the concept in the first knowledge graph and the candidate analogous concept in the at least one knowledge graph; and
returning the candidate analogous concept as the analogous concept based on a determination that the score for the candidate analogous concept exceeds a threshold score.

11. The system of claim 10, wherein the processor further configured to present the analogous concept to the user.

12. The system of claim 10, wherein determining the concept for the user comprises:
obtaining, by a sensor associated with a user device, sensor data taken from an interaction of the user with the concept; and
accessing the ontology for the user and a knowledge base to identify the concept using the sensor data.

13. (canceled)

14. The system of claim 10, wherein determining the analogous concept further comprises:
determining that the score for the candidate analogous concept does not exceed the threshold score;
accessing a second knowledge graph and performing a second semantic analysis on the second knowledge graph;
identifying a second candidate analogous concept in the second knowledge graph based on the second semantic analysis;
determining a second score for the second candidate analogous concept based on a second number of connected relationship paths between the concept in the first knowledge graph and the second candidate analogous concept in the second knowledge graph; and
returning the second candidate analogous concept as the analogous concept based on a determination that the second score for the second candidate analogous concept exceeds the threshold score.

15. A computer program product for analogy based recognition comprising a computer readable storage medium having program instructions embodied therewith, the program instructions executable by a processor to cause the processor to perform a method comprising:
determining an ontology for a user;
determining a concept for the user;
analyzing the concept and the ontology for the user to determine a familiarity score for the concept; and
determining an analogous concept for the concept responsive to determining that the familiarity score is below a threshold familiarity score, wherein determining the analogous concept comprises:
constructing a first knowledge graph for the concept based on knowledge base data;
performing a semantic analysis on the ontology of the user, wherein the ontology of the user comprises at least one knowledge graph;
identifying a candidate analogous concept in the ontology of the user based on the semantic analysis;
determining a score for the candidate analogous concept based on a number of connected relationship paths between the concept in the first knowledge graph and the candidate analogous concept in the at least one knowledge graph; and
returning the candidate analogous concept as the analogous concept based on a determination that the score for the candidate analogous concept exceeds a threshold score.

16. The computer program product of claim 15, further comprising presenting the analogous concept to the user.

17. The computer program product of claim 15, wherein determining the concept for the user comprises:
obtaining, by a sensor associated with a user device, sensor data taken from an interaction of the user with the concept; and
accessing the ontology for the user and a knowledge base to identify the concept using the sensor data.

18. (canceled)

19. The computer program product of claim 1815, wherein determining the analogous concept further comprises:
determining that the score for the candidate analogous concept does not exceed the threshold score;
accessing a second knowledge graph and performing a second semantic analysis on the second knowledge graph;
identifying a second candidate analogous concept in the second knowledge graph based on the second semantic analysis;
determining a second score for the second candidate analogous concept based on a second number of connected relationship paths between the concept in the first knowledge graph and the second candidate analogous concept in the second knowledge graph; and
returning the second candidate analogous concept as the analogous concept based on a determination that the second score for the second candidate analogous concept exceeds the threshold score.

20. The computer program product of claim 19, wherein the second knowledge graph is accessed from a second user ontology associated with a second user.
